(19) United States
(12) Patent Application Publication
(10) Pub. No.: US 2025/0123911 A1
(43) Pub. Date: Apr. 17, 2025

(54) DYNAMIC GENERATION OF MESH SERVICE

(71) Applicant: SAP SE, Walldorf (DE)

(72) Inventors: HUI LI, Shanghai (CN); Neng GAN, Shanghai (CN); Hongming XU, Shanghai (CN); Baolin He, Shanghai (CN); Jie Yao, Shanghai (CN)

(21) Appl. No.: 18/486,228

(22) Filed: Oct. 13, 2023

(51) Int. Cl. G06F 9/54

(52) U.S. Cl. CPC G06F 9/547

(57) ABSTRACT

Disclosed herein are system, method, and computer program product embodiments for a dynamic generation of a mesh service. An embodiment operates by receiving, by at least one processor, an input indicating a plurality of service containers, and retrieving a container image from a container repository responsive to the receiving of the input. The embodiment further operates by creating a new container image based on the container image and the plurality of service containers indicated in the input. In addition the embodiment operates by creating a component by calling an application programming interface (API) of an orchestration platform, and receiving, from the remote server, the additional user attribute data. Then the embodiment operates by creating the mesh service based on the new container image and the component.

### BACKGROUND

Nowadays, more and more software systems are migrating to microservices. The basic pattern of the microservices architecture is decomposing an application into small services by business capability or subdomain. The small services may be deployed in containers by using a software platform (e.g., Docker™) The containers may be managed by a container orchestration platform (e.g., Kubernetes™)

When multiple small services are deployed, a frontend or other services may want to retrieve data from the multiple small services simultaneously. In such cases, a layer called Backend for Frontend (BFF) may be implemented to combine data from multiple small services. However, the BFF layer requires much effort to incorporate a new requirement to add or change the combination strategy. Also, the BFF layer takes too much responsibility to combine many services, which may become a potential bottleneck or a source of single-point failure. Furthermore, it is hard to apply other features (e.g., resilience) in the BFF layer.

### BRIEF DESCRIPTION OF THE DRAWINGS

The accompanying drawings are incorporated herein and form a part of the specification.

FIG. 1 is a block diagram of a microservices architecture, according to some embodiments.

FIG. 2 is a flowchart for a method for generating a mesh service, according to some embodiments.

FIG. 3 is an example computer system that can be used for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for generating a mesh service dynamically.

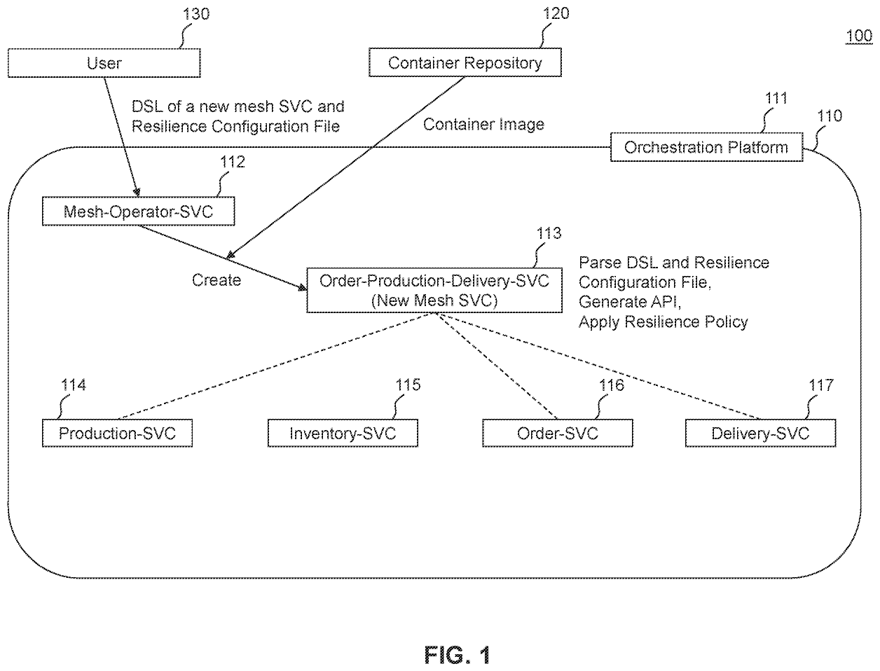

FIG. 1 is a block diagram of microservices architecture 100, according to some embodiments. The microservices architecture 100 may include service containers 110 managed by an orchestration platform. The microservices architecture 100 may also include container repository 120. The microservices architecture 100 may be used by a user 130.

The service containers 110 may include multiple service containers corresponding to microservices deployed in containers by using a software platform (e.g., Docker™) The service containers 110 may be managed by orchestration platform 111 (e.g., Kubernetes™) In this disclosure, e-commerce service is used as an example of an application composed by the microservices. The e-commerce service is only an example, and this disclosure is widely applicable to applications composed by multiple microservices. The service containers 110 may include Mesh-Operator-service (SVC) 112, Order-Production-Delivery-SVC 113, Production-SVC 114, Inventory-SVC 115, Order-SVC 116, and Delivery-SVC 117.

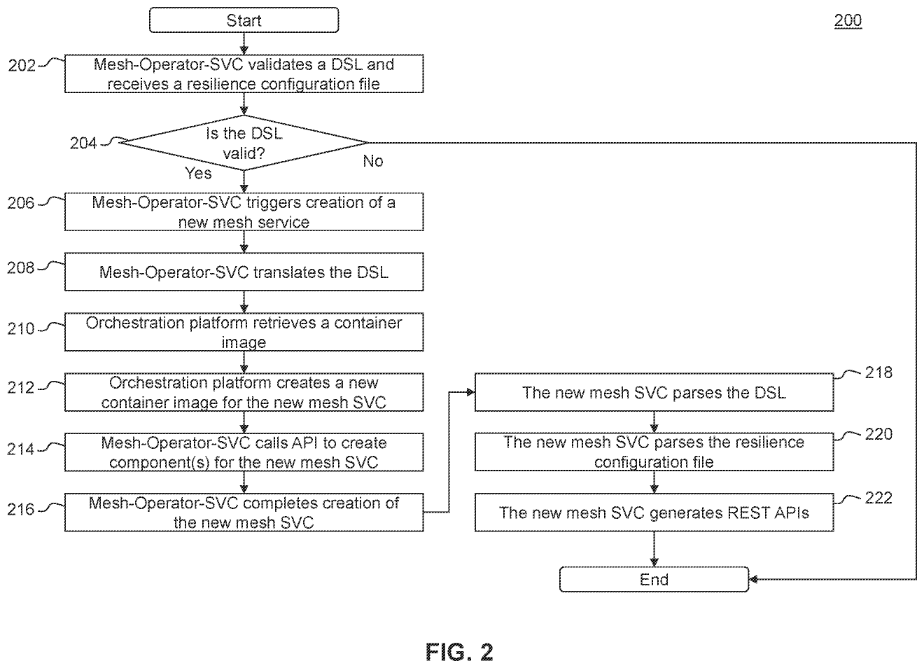

The Mesh-Operator-SVC 112 may observe and/or examine an input indicating multiple service containers. The input may be input by the user 130. The input may be a domain specific language (DSL) for generating a new mesh service. The mesh service is one of the services deployed in containers. The mesh service is designed to fetch data handled by other services across the board like a mesh. The input may also include a resilience configuration file. The Mesh-Operator-SVC 112 may trigger a creation of a new mesh service based on the input. Details are described below with respect to, for example, FIG. 2.

The Order-Production-Delivery-SVC 113 may be the new mesh service created in the service containers 110. The Order-Production-Delivery-SVC 113 is created based on the input and a container image retrieved from the container repository 120. The input may indicate that there is a need to retrieve data from one or more of the Order-SVC 116, the Production-SVC 114, and the Delivery-SVC 117. Then, the Mesh-Operator-SVC 112 triggers the creation of the Order-Production-Delivery-SVC 113 as the new mesh service. After the creation, the Order-Production-Delivery-SVC 113 may parse the input, generate application programming interface (API), and apply the resilience policy. The Order-Production-Delivery-SVC 113 may retrieve data from one or more of the Order-SVC 116, the Production-SVC 114, and the Delivery-SVC 117. Details are described below with respect to, for example, FIG. 2.

The Production-SVC 114 may handle the service of data on a production of products handled on the e-commerce service. The Production-SVC 114 may fetch (e.g., request and receive) the data as a service. The data handled by the Production-SVC 114 may include, a production ID, a production name, a production description, and a production vendor.

The Inventory-SVC 115 may handle the service of data on an inventory of the products handled on the e-commerce service. The Inventory-SVC 115 may fetch (e.g., request and receive) the data as a service. The data handled by the Inventory-SVC 115 may include, an inventory ID, an inventory name, and an inventory description.

The Order-SVC 116 may handle the service of data on an order of the products handled on the e-commerce service. The Order-SVC 116 may fetch (e.g., request and receive) the data as a service. The data handled by the Order-SVC 116 may include, an order ID, an order customer name, an order create date, an order address, an order status, and an order price.

The Delivery-SVC 117 may handle the service of data on a delivery of the products handled on the e-commerce service. The Delivery-SVC 117 may fetch (e.g., request and receive) the data as a service. The data handled by the Delivery-SVC 117 may include, a delivery status, a current city of a delivery, and a delivery express company.

The container repository 120 may store the container image. The container image may be a template for creating the new mesh service.

FIG. 2 is a flowchart for a method 200 for generating a mesh service, according to some embodiments. Method 200 can be performed by a processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. The method 200 shall be described with reference to FIG. 1. However, method 200 is not limited to that example embodiment.

In 202, the Mesh-Operator-SVC 112 may receive an input from the user 130 and may validate the input from the user 130. The input may indicate multiple service containers of the service containers 110. For example, the input may define a field (e.g., the “baseServices” field described below) to indicate multiple service containers of the service containers 110. The indicated multiple service containers may represent sources of data fetched by the new mesh service. The input may define other and additional fields. The service containers 110 may include one or more of the Mesh-Operator-SVC 112, the Production-SVC 114, the Inventory-SVC 115, the Order-SVC 116, and the Delivery-SVC 117. According to some embodiments, the service containers 110 may not include the Order-Production-Delivery-SVC 113, because the Order-Production-Delivery-SVC 113 is not created yet. The Mesh-Operator-SVC 112 may observe and/or examine the input. In response to receiving the input, the Mesh-Operator-SVC 112 may validate the input. The validation may involve one or more tests, which may include, a syntax check, a format check, and a semantic check. The Mesh-Operator-SVC 112 may perform the syntax check by checking each line of the input. The Mesh-Operator-SVC 112 may perform the format check by verifying whether the input follows the predetermined format. The Mesh-Operator-SVC 112 may perform the semantic check by verifying whether the service containers or other objects referred to by the input are valid. The input may be the DSL. The input may indicate multiple representational state transfer (REST) APIs of the multiple service containers. An example of the input described in DSL is shown below.

```
{
  ″service″: ″Order-Production-Delivery-SVC″,
  ″image″: ″Mesh-SVC:latest″,
  “baseServices”: [″Order-svc”, “Production-svc”, “Delivery-svc”]
  ″apis″: [
      {
        ″uri″: ″/rest/OrderProduction″,
        ″fields″: {
        ″orderId″: ″Order-svc.Order.orderId″,
        ″orderCreateDate″: ″Order-svc.Order.createDate″,
        ″orderCustomerName″: ″Order-svc.Order.customerName″,
        ″orderAddress″: ″Order-svc.Order. address″,
        ″orderStatus″: ″Order-svc.Order.status″,
        ″orderPrice″: ″Order-svc.Order.price″,
        ″productionId″: ″Production-svc.Production.id″,
        ″productionName″: “Production-svc.Production.name″,
        ″productionDesc″: ″Production-svc.Production.desc″,
        ″productionVendor″: “Production-svc.Production.vendor″
      },
        ″associations″: [
        “Order-svc.Order.productionId=Production-svc.Production.id″
      ]
    },
    {
        ″uri″: ″/rest/OrderProductionDelivery″,
        ″fields″: {
        ″orderId″: ″Order-svc.Order.orderId″,
        ″orderCreateDate″: ″Order-svc.Order.createDate″,
        ″orderCustomerName″: ″Order-svc.Order.customerName″,
        ″orderAddress″: ″Order-svc.Order. address″,
        ″orderStatus″: ″Order-svc.Order.status″,
        ″orderPrice″: ″Order-svc.Order.price″,
        ″productionId″: ″Production-svc.Production.id″,
        ″productionName″: ″Production-svc.Production.name″,
        ″productionDesc″: ″Production-svc.Production.desc″,
        ″productionVendor″: ″Production-svc.Production.vendor″,
        ″deliveryStatus″: ″Delivery-svc.Delivery.status″,
        ″deliveryCurrentCity″: ″Delivery-svc.Delivery.currentCity″,
        ″deliveryExpressCompany ″:
        ″Delivery-svc.Delivery.expressCompany″
      },
        ″associations″: [
        ″Order-svc.Order.productionId=Production-svc.Production.id″,
        ″Order-svc.Order.orderId=Delivery-svc.Delivery.orderId″
      ]
    }
  ]
}
```

This is an exemplary input and the embodiments of this disclosure are not limited to this example.

The field “service” may define the new mesh service name “Order-Production-Delivery-SVC.” The field “image” may define the container image “Mesh-SVC: latest,” which is the template of the new mesh service retrieved from the container repository 120. The field “baseServices” may indicate existing service containers the Order-SVC 116, the Production-SVC 114, and the Delivery-SVC 117, which will be used to create the new mesh service.

The field “apis” may define two RESTful APIs whose Uniform Resource Identifier (URI) s are “/rest/OrderProduction” and “/rest/OrderProductionDelivery” for the new mesh service. In this disclosure, REST API is a concept that includes RESTful APIs. The field “fields” defines how the fields of new restful APIs map to the fields of resources of the existing base services.

The field “associations” may define how to join the existing base services for the new mesh service. The field “fields” may define how the fields of new restful APIs map to the fields of resources of the existing service containers.

In 202, the Mesh-Operator-Service-SVC 113 may also receive the resilience configuration file as the input. An example of a content of the resilience configuration file is shown below.

```
  //Define resilience instances
resilience4j.circuitbreaker:
  configs:
    default:
      failureRateThreshold: 50
      slowCallRateThreshold: 50
      slowCallDurationThreshold: 60000ms
      permittedNumberOfCallsInHalfOpenState: 100
      slidingWindowType: COUNT_BASED
      slidingWindowSize: 100
      minimumNumberOfCalls: 100
      waitDurationInOpenState: 60000ms
  instances:
    circuitbreaker_01:
resilience4j.ratelimiter:
  configs:
    default:
      timeoutDuration: 5s
      limitRefreshPeriod: 500ns
      limitForPeriod: 50
  instances:
    ratelimiter_01:
resilience4j.retry:
  configs:
    default:
        maxAttempts: 3
        waitDuration: 500ms
        enableExponentialBackoff: true
        exponentialBackoffMultiplier: 1.5
  instances:
    retry_01:
resilience4j.bulkhead:
  configs:
    default:
      maxWaitDuration: 0
      maxConcurrentCalls: 25
  instances:
    bulkhead_01:
... ...
//Define resilience instance mapping
resilience.mapping:
  - url-mapping: [“/rest/OrderDelivery″, “/rest/OrderProductionDelivery”]
    circuitbreaker-instance: circuitbreaker_01
    ratelimiter-instance: ratelimiter_01
    retry-instance: retry_01
    bulkhead-instance: bulkhead_01
```

This resilience configuration file is provided as a non-limiting example. The embodiments of this disclosure can include other resilience configuration files. The resilience configuration file may define one circuitbreaker instance, one ratelimiter instance, one retry instance, and one bulkhead instance, and make the new mesh service's API/rest/OrderDelivery and/rest/OrderProductionDelivery use the four resilience instances. The circuitbreaker instance may set thresholds or parameters related to calls of the new mesh service. The ratelimiter instance may set thresholds or parameters to limit a rate of incoming requests for the new mesh service. The retry instance may set thresholds or parameters for retry-accesses to the new mesh service. The bulkhead instance may set thresholds or parameters to limit the number of concurrent execution of the new mesh service. In this disclosure the resilience configuration file is one example of configuration files. In other words, if it is desired to implement a new feature in the new mesh service, it can be done by inputting the configuration file for the new feature.

In 204, if a validation result indicates that the input is valid, the operation of the Mesh-Operator-SVC 112 proceed to 206. In 206, the Mesh-Operator-SVC 112 may trigger the creation of the new mesh service

In 208, the Mesh-Operator-SVC 112 may translate the input to a service definition, which conforms to a format of the orchestration platform 111. For example, the Mesh-Operator-SVC 112 may translate the DSL to the service definition.

In 210, the orchestration platform 111 may retrieve the container image from the container repository 120. The orchestration platform 111 may retrieve the container image according to the service definition translated in 208. For example, the orchestration platform 111 may retrieve the container image of Mesh-SVC: latest from the container repository 120. If the input includes the resilience configuration file, the retrieved container image may be integrated with a resilience library. The retrieved image may be a template of the new mesh service for pursing the DSL and generating restful API according to the input.

In 212, the orchestration platform 111 may create a new container image for the new mesh service. The orchestration platform 111 may create a new container image based on the retrieved container image and the plurality of service containers (the multiple service containers of the service containers 110) indicated in the input.

In 214, the Mesh-Operator-SVC 112 may call an API to create components for the new mesh service. The components may be necessary components to establish the new mesh service so that the new mesh service can actually be operational. For example, the Mesh-Operator-SVC 112 may call an API of the orchestration platform 111 to create necessary components for the Order-Production-Delivery-SVC 113 as the new mesh service, such as Pod, ReplicaSet, Endpoint, Ingress, Service, and Deployment.

In 216, the Mesh-Operator-SVC 112 may complete the creation of the new mesh service. For example, the Mesh-Operator-SVC 112 may complete the creation of the Order-Production-Delivery-SVC 113. After the creation of the new mesh service, the Mesh-Operator-SVC 112 may run the new mesh service. For example, after the creation of the Order-Production-Delivery-SVC 113, the Mesh-Operator-SVC 112 may run the Order-Production-Delivery-SVC 112. Running the new mesh service allows the new mesh service to allow to parse the input and generate REST(ful) APIs.

In 218, the new mesh service may parse the input. For example, the Order-Production-Delivery-SVC 113 may parse the DSL of the input.

In 220, the new mesh service parses the resilience configuration file. For example, the Order-Production-Delivery-SVC 113 may parse the resilience configuration file shown above. The Order-Production-Delivery-SVC 113 may apply a resilience strategy according to the resilience configuration file so that the Order-Production-Delivery-SVC 113 has a predetermined resilience. In 220, the Order-Production-Delivery-SVC 113 may determine whether the input includes the configuration file. The Order-Production-Delivery-SVC 113 may not parse the configuration file (e.g., the resilience configuration file) if the Order-Production-Delivery-SVC 113 determines that the input does not include the configuration file.

In 222, the new mesh service may generate REST(ful) APIs. For example, Order-Production-Delivery-SVC 113 may generate the REST(ful) APIs indicate in the input. The generated REST(ful) APIs may retrieve the data from the multiple service containers. The retrieved data may be output to the user 130 or used by other services.

As such, Order-Production-Delivery-SVC 113 may retrieve the required data from the Order-SVC 116, the Production-SVC 114, and the Delivery-SVC 117 by using the API, as indicated by the dashed line in FIG. 1. In this way, the microservices architecture 100 can generate new mesh services dynamically based on existing service containers. The new mesh service may only take responsibility for combining a limited number of services containers, so that the new mesh service may not be the bottleneck or source of single-point failure. Furthermore, by using the configuration file (e.g., resilience configuration file,) the microservices architecture 100 can apply the new feature to the new mesh service instantly.

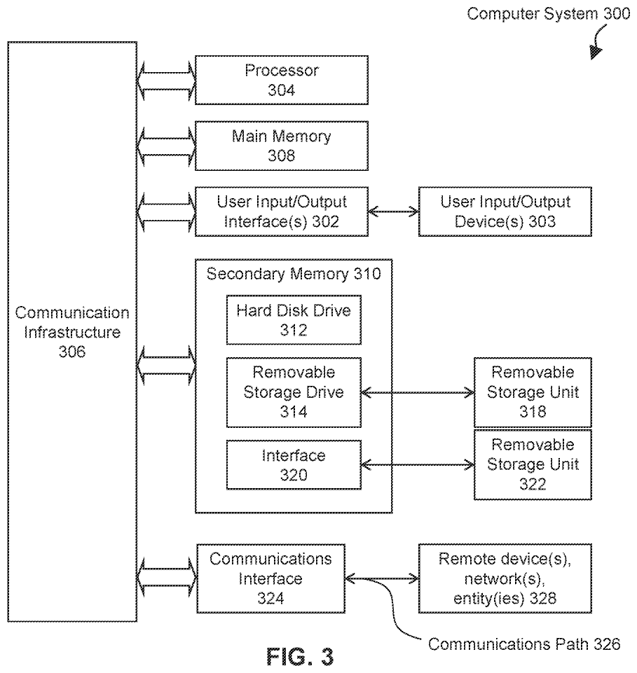

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for generating a mesh service, comprising:
receiving, by at least one processor, an input indicating a plurality of service containers;
retrieving a container image from a container repository responsive to the receiving of the input;
creating a new container image based on the container image and the plurality of service containers indicated in the input;
creating a component by calling an application programming interface (API) of an orchestration platform; and
creating the mesh service based on the new container image and the component.

2. The computer-implemented method of claim 1, wherein the input indicates a plurality of representational state transfer (REST) APIs of the plurality of service containers, and the computer-implemented method further comprises:
running the mesh service;
parsing the input with the mesh service;
generating the REST APIs indicated in the input with the mesh service; and
outputting, to a user, data retrieved by the REST APIs.

3. The computer-implemented method of claim 1, wherein the input is a domain specific language (DSL), and the computer-implemented method further comprises:
validating the DSL in response to receiving the DSL, wherein the retrieving the container image is performed in response to a validation result indicating that the DSL is valid.

4. The computer-implemented method of claim 3, further comprising:
translating the DSL to a service definition, wherein the retrieving the container image is performed based on the service definition.

5. The computer-implemented method of claim 1, wherein the retrieving the container image comprises retrieving the container image indicated in the input as a template.

6. The computer-implemented method of claim 1, further comprising:
receiving a resilience configuration file, wherein the retrieving the container image comprises retrieving the container image integrated with a resilience library; and
applying a resilience strategy in based on the resilience configuration file and the resilience library.

7. The computer-implemented method of claim 6, wherein the resilience configuration file indicates at least one of a circuit breaker instance, a rate limiter instance, a retry instance, and a bulkhead instance.

8. A system for generating a mesh service, comprising:
a memory; and
at least one processor coupled to the memory and configured to:
receive an input indicating a plurality of service containers;
retrieve a container image from a container repository responsive to the receiving of the input;
create a new container image based on the container image and the plurality of service containers indicated in the input;
create a component by calling an application programming interface (API) of an orchestration platform; and
creating the mesh service based on the new container image and the component.

9. The system of claim 8, wherein the input indicates a plurality of REST (representational state transfer) APIs of the plurality of service containers, and the at least one processor further configured to:
run the mesh service;
parse the input with the mesh service;
generate the REST APIs indicated in the input with the mesh service; and
output to a user, data retrieved by the REST APIs.

10. The system of claim 8, wherein the input is a domain specific language (DSL), and the at least one processor further configured to:
validate the DSL in response to receiving the DSL, wherein the retrieving the container image is performed in response to a validation result indicating that the DSL is valid.

11. The system of claim 10, wherein the at least one processor further configured to:
translate the DSL to a service definition, wherein the retrieving the container image is performed based on the service definition.

12. The system of claim 8, wherein the container image retrieved is indicated in the input as a template.

13. The system of claim 8, wherein the at least one processor further configured to:
receive a resilience configuration file, wherein the retrieving the container image comprises retrieving the container image integrated with a resilience library; and
apply a resilience strategy in based on the resilience configuration file and the resilience library.

14. The system of claim 13, wherein the resilience configuration file indicates at least one of a circuit breaker instance, a rate limiter instance, a retry instance, and a bulkhead instance.

15. A non-transitory computer-readable medium having instructions stored thereon that, when executed by at least one computing device, cause the at least one computing device to perform operations comprising:
receiving an input indicating a plurality of service containers;
retrieving a container image from a container repository responsive to the receiving of the input;
creating a new container image based on the container image and the plurality of service containers indicated in the input;
creating a component by calling an application programming interface (API) of an orchestration platform; and
creating a mesh service based on the new container image and the component.

16. The non-transitory computer-readable medium of claim 15, wherein the input indicates a plurality of REST (representational state transfer) APIs of the plurality of containers, and the operations further comprising:
running the mesh service;
parsing the input with the mesh service;
generating the REST APIs indicated in the input with the mesh service; and
outputting, to a user, data fetched by the REST APIs.

17. The non-transitory computer-readable medium of claim 15, wherein the input is a domain specific language (DSL), and the operations further comprising:
validating the DSL in response to receiving the DSL, wherein the retrieving the container image is performed in response to a validation result indicating that the DSL is valid.

18. The non-transitory computer-readable medium of claim 15, the operations further comprising:
translating the DSL to a service definition, wherein the retrieving the container image is performed based on the service definition.

19. The non-transitory computer-readable medium of claim 15, wherein the retrieving the container image comprises retrieving the container image indicated in the input as a template.

20. The non-transitory computer-readable medium of claim 15, the operations further comprising:
receiving a resilience configuration file, wherein the retrieving the container image comprises retrieving the container image integrated with a resilience library; and
applying a resilience strategy in based on the resilience configuration file and the resilience library.
